(19) United States
(12) Patent Application Publication
(10) Pub. No.: US 2025/0219765 A1
(43) Pub. Date: Jul. 3, 2025

(54) APPARATUS, SYSTEM, AND METHOD OF COMMUNICATING FEEDBACK INFORMATION IN A MULTI STATION BLOCK ACKNOWLEDGEMENT FRAME

(71) Applicants: Laurent Cariou, Milizac (FR); Po-Kai Huang, San Ramon, CA (US); Danny Alexander, Monoson (IL)

(72) Inventors: Laurent Cariou, Milizac (FR); Po-Kai Huang, San Ramon, CA (US); Danny Alexander, Monoson (IL)

(21) Appl. No.: 19/068,338

(22) Filed: Mar. 3, 2025

Related U.S. Application Data
(60) Provisional application No. 63/561,192, filed on Mar. 4, 2024.

(51) Int. Cl. H04L 1/00; H04L 1/1607; H04L 5/00; H04W 28/18

(52) U.S. Cl. CPC H04L 1/0073; H04L 1/0015; H04L 1/0057; H04L 1/1621; H04L 1/1642; H04L 5/0055; H04W 28/18

(57) ABSTRACT

For example, an apparatus may include logic and circuitry configured to cause a wireless communication station (STA) to set an acknowledge (Ack) type subfield in a per Association Identifier (AID) Traffic Identifier (TID) Information (info) field to 0 and a TID subfield in the per AID TID info field to 13, for example, to indicate that the per AID TID info field is to include feedback information. For example, the STA may be configured to set the feedback information in a feedback subfield in the per AID TID info field. For example, the STA may be configured transmit a multi-STA Block Ack (BA) frame including the per AID TID info field.

### CROSS REFERENCE

This Application claims the benefit of and priority from U.S. Provisional Patent Application No. 63/561,192 entitled “Feedback in Multi Station Device Block Acknowledgement Frame”, filed Mar. 4, 2024, the entire disclosure of which is incorporated herein by reference.

### BACKGROUND

Devices in a wireless communication system may be configured to communicate various types of frames, which may include, for example, data frames, control frames, or the like.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a multi-station (multi-STA) Block Acknowledge (BA) frame, in accordance with some demonstrative aspects.

FIG. 3 is a schematic illustration of a multi-STA BA frame, in accordance with some demonstrative aspects.

FIG. 4 is a schematic flow-chart illustration of a method of communicating feedback information in a multi-STA BA frame, in accordance with some demonstrative aspects.

FIG. 5 is a schematic flow-chart illustration of a method of communicating feedback information in a multi-STA BA frame, in accordance with some demonstrative aspects.

FIG. 6 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks Specific Requirements; Part 11: Wireless LAN Medium Access Control (MAC) and Physical Layer (PHY) Specifications, December, 2020); IEEE 802.11ax (IEEE 802.11ax-2021, IEEE Standard for Information Technology—Telecommunications and Information Exchange between Systems Local and Metropolitan Area Networks Specific Requirements; Part 11: Wireless LAN Medium Access Control (MAC) and Physical Layer (PHY) Specifications; Amendment 1: Enhancements for High-Efficiency WLAN, February 2021); IEEE 802.11be (IEEE P802.11be/D5.0 Draft Standard for Information technology—Telecommunications and information exchange between systems Local and metropolitan area networks Specific requirements; Part 11: Wireless LAN Medium Access Control (MAC) and Physical Layer (PHY) Specifications; Amendment 8: Enhancements for extremely high throughput (EHT), November 2023); and/or IEEE802.11bn (IEEE 802.11bn/D0.1, IEEE Standard for Information Technology—Telecommunications and Information Exchange between Systems Local and Metropolitan Area Networks Specific Requirements; Part 11: Wireless LAN Medium Access Control (MAC) and Physical Layer (PHY) Specifications—Amendment: Enhancements for Ultra High Reliability (UHR), January 2025)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™ Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a Wi-Fi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 GHz and 300 GHz, for example, a frequency band above 45 GHz, e.g., a 60 GHz frequency band, and/or any other mmWave frequency band. Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

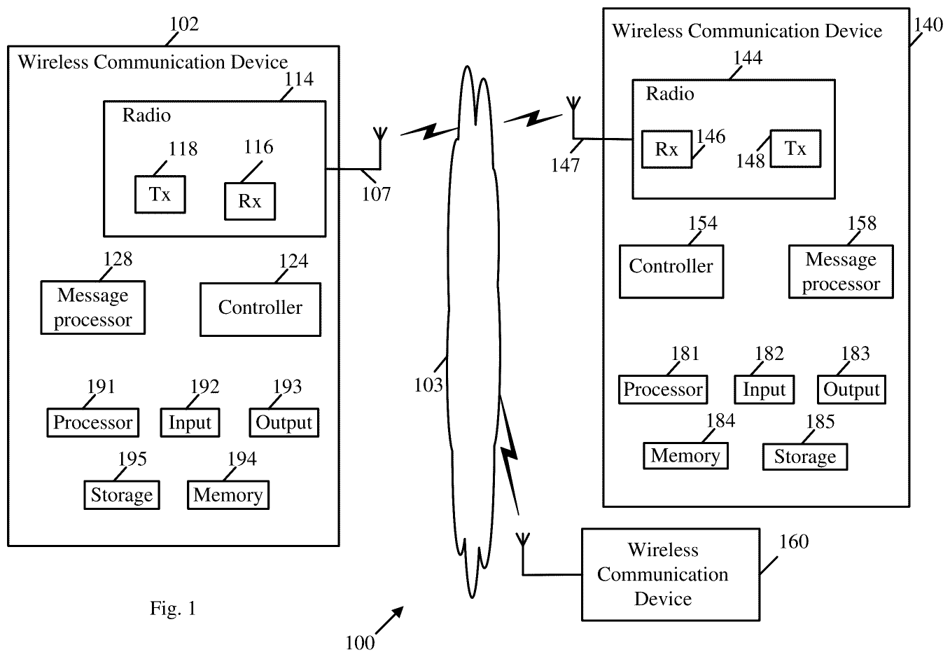

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, an RF channel, a Wi-Fi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 GHz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternatively include one or more channels in an mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices. For example, device 102 may include one or more radios 114, and/or device 140 may include one or more radios 144.

In some demonstrative aspects, radios 114 and/or radios 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, and/or any other band, for example, a directional band, e.g., an mmWave band, a 5G band, an SlG band, and/or any other band.

In some demonstrative aspects, radios 114 and/or 144 may include, or may be associated with one or more antennas.

In some demonstrative aspects, device 102 may include one or more antennas 107, and/or device 140 may include one or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102, device 140, and/or device 160 may include, operate as, perform the role of, and/or perform one or more functionalities of, one or more STAs. For example, device 102 may include at least one STA, device 140 may include at least one STA, and/or device 160 may include at least one STA.

In some demonstrative aspects, device 102, device 140, and/or device 160 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102, device 140, and/or device 160 may be configured to perform one or more operations, and/or functionalities of a Wi-Fi 8 STA.

In other aspects, for example, devices 102, 140 and/or 160 may be configured to perform one or more operations, and/or functionalities of an Ultra High Reliability (UHR) STA.

In other aspects, for example, devices 102, 140, and/or 160 may be configured to perform one or more operations, and/or functionalities of any other additional or alternative type of STA.

In other aspects, device 102, device 140, and/or device 160 may include, operate as, perform the role of, and/or perform one or more functionalities of, any other wireless device and/or station, e.g., a WLAN STA, a Wi-Fi STA, and the like.

In some demonstrative aspects, device 102, device 140, and/or device 160 may be configured operate as, perform the role of, and/or perform one or more functionalities of, an Access Point (AP), e.g., a High Throughput (HT) AP STA, a High Efficiency (HE) AP STA, an EHT AP STA and/or a UHR AP STA.

In some demonstrative aspects, device 102, device 140, and/or device 160 may be configured to operate as, perform the role of, and/or perform one or more functionalities of, a non-AP STA, e.g., an HT non-AP STA, an HE non-AP STA, an EHT non-AP STA and/or a UHR non-AP STA.

In other aspects, device 102, device 140, and/or device 160 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102, 140, and/or 160 may be configured to communicate in an HT network, an HE network, an EHT network, a UHR network, and/or any other network.

In some demonstrative aspects, devices 102, 140 and/or 160 may be configured to operate in accordance with one or more Specifications, for example, including one or more IEEE 802.11 Specifications, e.g., an IEEE 802.11-2020 Specification, an IEEE 802.11ax Specification, an IEEE 802.11be Specification, an IEEE 802.11bn Specification, and/or any other specification and/or protocol.

In some demonstrative aspects, device 102, device 140, and/or device 160 may include, operate as, perform a role of, and/or perform the functionality of, a Multi-Link Device (MLD). For example, device 102 may include, operate as, perform a role of, and/or perform the functionality of, at least one MLD, device 140 may include, operate as, perform a role of, and/or perform the functionality of, at least one MLD, and/or device 160 may include, operate as, perform a role of, and/or perform the functionality of, at least one MLD, e.g., as described below.

For example, an MLD may include a device that is a logical entity that is capable of supporting more than one affiliated station (STA) and can operate using one or more affiliated STAs. For example, the MLD may present one Medium Access Control (MAC) data service and a single MAC Service Access Point (SAP) to the Logical Link Control (LLC) sublayer. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102, device 140, and/or device 160 may be configured to operate as, perform the role of, and/or perform one or more functionalities of, an AP MLD.

In some demonstrative aspects, device 102, device 140, and/or device 160 may be configured to operate as, perform the role of, and/or perform one or more functionalities of, a non-AP MLD.

In other aspects, device 102, device 140, and/or device 160 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In some demonstrative aspects, device 102, device 140, and/or device 160 may include, operate as, perform a role of, and/or perform the functionality of, one or more AP STAs and/or one or more non-AP STAs. In one example, device 102 may include, operate as, perform a role of, and/or perform the functionality of, at least one AP STA, and/or device 140 may include, operate as, perform a role of, and/or perform the functionality of, at least one non-AP STA.

In some demonstrative aspects, device 102 may include, operate as, perform a role of, and/or perform the functionality of, a first STA, e.g., an AP STA or a non-AP STA.

In some demonstrative aspects, device 140 may include, operate as, perform a role of, and/or perform the functionality of, a second STA, e.g., an AP STA or a non-AP STA.

In some demonstrative aspects, device 160 may include, operate as, perform a role of, and/or perform the functionality of, a third STA, e.g., an AP STA or a non-AP STA.

In other aspects, device 102, device 140, and/or device 160 may include, operate as, perform a role of, and/or perform the functionality of any other additional or alternative type of STA.

In some demonstrative aspects, device 102, device 140, and/or device 160 may be configured to communicate one or more PPDUs, for example, in accordance with an IEEE 802.11 Specification.

In some demonstrative aspects, device 102, device 140, and/or device 160 may be configured to generate, transmit, receive, and/or process one or more transmissions of PPDUs, e.g., as described below.

In some demonstrative aspects, device 102, device 140, and/or device 160 may be configured to configured to implement one or more operations and/or functionalities of a feedback mechanism, which may be configured to support communication of feedback information in one or more initial control frames, e.g., as described below.

For example, the feedback mechanism may be configured to support communicating the feedback information in a first frame in a Transmit opportunity (TxOP), for example, in a request to send (RTS) frame, and/or any other suitable initial control frame.

In some demonstrative aspects, device 102, device 140, and/or device 160 may be configured to configured to implement one or more operations and/or functionalities of a feedback mechanism, which may be configured to support communication of feedback information in one or more initial response frames, e.g., as described below.

For example, the feedback mechanism may be configured to support communicating the feedback information in a response frame to an initial control frame, for example, in a clear to send (CTS) frame, and/or any other suitable initial response frame.

In some demonstrative aspects, device 102, device 140, and/or device 160 may be configured to configured to implement one or more operations and/or functionalities of a feedback mechanism, which may be configured to support communication of feedback information in one or more control response frames, e.g., as describe below.

For example, the feedback mechanism may be configured to support communicating the feedback information in a Block Acknowledgement (BA) frame, or any other suitable control response frame.

In some demonstrative aspects, device 102, device 140, and/or device 160 may be configured to configured to implement one or more operations and/or functionalities of a feedback mechanism, which may be configured to support communicating feedback information in a multi-STA (mSTA) BA frame, e.g., as described below.

In some demonstrative aspects, the multi-STA BA frame may be configured to provide a BA in response to a PPDU containing data frames.

In some demonstrative aspects, the multi-STA BA frame may be utilized as an Initial Control Response (ICR) frame, e.g., as described below.

In some demonstrative aspects, the multi-STA BA frame may be configured to include one or more types, e.g., a plurality of different types, of feedback, e.g., as described below.

In some demonstrative aspects, device 102, device 140, and/or device 160 may be configured to configured to implement one or more operations and/or functionalities of a feedback mechanism, which may be configured to support communicating feedback including link adaptation information, for example, in an ICR frame and/or a BA frame, e.g., as described below.

In some demonstrative aspects, device 102, device 140, and/or device 160 may be configured to configured to implement one or more operations and/or functionalities of a feedback mechanism, which may be configured to support communicating feedback including coexistence information, for example, in an ICR frame and/or a BA frame, e.g., as described below.

For example, the coexistence information may include unavailability information, e.g., as described below. In other aspects, the coexistence information may include any other suitable additional or alternative information.

In some demonstrative aspects, device 102, device 140, and/or device 160 may be configured to configured to implement one or more operations and/or functionalities of a feedback mechanism, which may be configured to support communicating feedback including coexistence information, for example, to characterize a receive status due to interference, e.g., as described below.

For example, the coexistence information may include a 1-bit field in a BA frame, for example, to indicate the receive status due to interference, e.g., as described below. In other aspects, any other suitable additional or alternative field, e.g., including one bit or more than one bit, may be configured to indicate the receive status due to interference.

In some demonstrative aspects, device 102, device 140, and/or device 160 may be configured to configured to implement one or more operations and/or functionalities of a feedback mechanism, which may be configured to support communicating feedback including parameter negotiation information, for example, in an ICR frame, e.g., as described below.

In some demonstrative aspects, device 102, device 140, and/or device 160 may be configured to implement one or more operations and/or functionalities of a feedback mechanism, which may be configured to support communicating feedback in one or more broadcast frames, e.g., as described below.

In some demonstrative aspects, device 102, device 140, and/or device 160 may be configured to implement one or more operations and/or functionalities of a feedback mechanism, which may be configured to support communicating feedback in one or more unicast frames, e.g., as described below.

In some demonstrative aspects, device 102, device 140, and/or device 160 may be configured to implement one or more operations and/or functionalities of a feedback mechanism, which may be configured to support communicating feedback for a single destination, e.g., as described below.

For example, the feedback mechanism may be configured to support communicating feedback for a single destination in an ICR frame sent in an UL to an AP.

For example, the feedback mechanism may be configured to support communicating feedback for a single destination in an ICR frame sent in a DL to a STA.

For example, the feedback mechanism may be configured to support communicating feedback for a single destination in a BA frame sent in an UL to an AP.

In some demonstrative aspects, device 102, device 140, and/or device 160 may be configured to implement one or more operations and/or functionalities of a feedback mechanism, which may be configured to support communicating feedback for multiple destinations, for example, in case the feedback includes link adaptation information and/or any other suitable information for multiple destinations, e.g., as described below.

In some demonstrative aspects, device 102, device 140, and/or device 160 may be configured to implement one or more operations and/or functionalities of a feedback mechanism, which may be configured to support communicating feedback for multiple destinations, for example, in case the feedback includes per-STA feedback in a multi-STA DL, e.g., as described below.

For example, the feedback mechanism may be configured to support communicating feedback for multiple destinations in a multi-STA BA frame sent in a DL to multiple STAs, e.g., multiple STAs that sent a UL trigger based (TB) PPDU.

For example, device 102 may transmit to device 140 and/or device 160 a multi-STA BA frame including feedback information for device 140 and/or device 160, for example, in response to an UL TB PPDU from device 140 and/or device 160.

In some demonstrative aspects, the feedback for multiple destinations may include feedback including link adaptation information.

In some demonstrative aspects, the feedback for multiple destinations may include feedback including coexistence information, e.g., unavailability information, which may be utilized by one or more mobile APs.

In some demonstrative aspects, the feedback for multiple destinations may include feedback including coexistence information, e.g., including information to characterize a receive status due to interference. In one example, the information to characterize a receive status due to interference may be implemented with a single bit, e.g., a reserved bit, in a multi-STA BA frame.

In some demonstrative aspects, device 102, device 140, and/or device 160 may be configured to implement one or more operations and/or functionalities of a feedback mechanism, which may be configured to provide a technical solution to support communicating feedback for a single destination, for example, when a frame including the feedback is unicasted, e.g., as described below.

In some demonstrative aspects, device 102, device 140, and/or device 160 may be configured to implement one or more operations and/or functionalities of a feedback mechanism, which may be configured to provide a technical solution to support communicating feedback for multiple destinations, for example, when a frame including the feedback is broadcasted to multiple intended receivers, for example, each to be provided with different feedback, e.g., as described below.

In some demonstrative aspects, controller 124 may be configured to control, trigger, cause, and/or instruct a STA implemented by device 102 to set an acknowledge (Ack) type subfield in a per Association Identifier (AID) Traffic Identifier (TID) Information (info) field to 0 and a TID subfield in the per AID TID info field to 13, for example, to indicate that the per AID TID info field is to include feedback information, e.g., as described below.

In other aspects, the Ack type subfield and the TID subfield may include any other combination of values to indicate that the per AID TID info field includes feedback information.

In some demonstrative aspects, controller 124 may be configured to control, trigger, cause, and/or instruct the STA implemented by device 102 to set the feedback information in a feedback subfield in the per AID TID info field, e.g., as described below.

In some demonstrative aspects, controller 124 may be configured to control, trigger, cause, and/or instruct the STA implemented by device 102 to transmit a multi-STA BA frame including the per AID TID info field, e.g., as described below.

In some demonstrative aspects, controller 124 may be configured to control, trigger, cause, and/or instruct the STA implemented by device 102 to set the Ack type subfield of the per AID TID info field to 0 and the TID subfield of the per AID TID info field to 13, for example, to indicate that the per AID TID info field is to include the feedback information, for example, instead of ack information, e.g., as described below.

In some demonstrative aspects, controller 124 may be configured to control, trigger, cause, and/or instruct the STA implemented by device 102 to set the Ack type subfield of the per AID TID info field to 0 and the TID subfield of the per AID TID info field to 13, for example, to indicate that the per AID TID info field is to include the feedback subfield, for example, instead of a BA bitmap subfield, e.g., as described below.

In some demonstrative aspects, controller 124 may be configured to control, trigger, cause, and/or instruct the STA implemented by device 102 to set a BA starting sequence control subfield in the per AID TID info field, for example, to indicate a length of the feedback subfield, e.g., as described below.

In some demonstrative aspects, controller 124 may be configured to control, trigger, cause, and/or instruct the STA implemented by device 102 to set the BA starting sequence control subfield in the per AID TID info field, for example, to indicate a selected length from a plurality of predefined lengths, e.g., as described below.

In some demonstrative aspects, the selected length may be based on the length of the feedback subfield, e.g., as described below.

In some demonstrative aspects, controller 124 may be configured to control, trigger, cause, and/or instruct the STA implemented by device 102 to set the BA starting sequence control subfield in the per AID TID info field to indicate a length of 4, 8, 16, or 32 octets, for example, based on the length of the feedback subfield, e.g., as described below.

In other aspects, the feedback subfield may have any other suitable length.

In some demonstrative aspects, controller 124 may be configured to control, trigger, cause, and/or instruct the STA implemented by device 102 to set a fragment number subfield in the BA starting sequence control subfield, for example, to indicate the length of the feedback subfield, e.g., as described below.

In some demonstrative aspects, controller 124 may be configured to control, trigger, cause, and/or instruct the STA implemented by device 102 to set the fragment number subfield in the BA starting sequence control subfield, e.g., as follows:

TABLE 1

| | | | | BA Bitmap | Maximum |
|---|---|---|---|---|---|
| | | | | subfield or | number of |
| Fragment | | | Fragmentation | Feedback | MSDUs/A-MSDUs |
| number subfield | | | level 3 | length | that can be |
| B3 | B2-B1 | B0 | (ON/OFF) | (octets) | acknowledged |
| 0 | 0 | 0 | OFF | 8 | 64 |
| 0 | 1 | 0 | | 16 | 128 |
| 0 | 2 | 0 | | 32 | 256 |
| 0 | 3 | 0 | | 4 | 32 |
| 0 | 0 | 1 | ON | 8 | 16 |
| 0 | 1 | 1 | | 16 | 32 |
| 0 | 2 | 1 | | 32 | 64 |
| 0 | 3 | 1 | | 4 | 8 |

For example, as shown in Table 1, the bits of the fragment number subfield in the BA starting sequence control subfield may be set to a predefined value, which may be based in the length of the feedback subfield.

For example, as shown in Table 1, it may be defined that the same setting of the fragment number subfield in the BA starting sequence control subfield may be used to indicate the length of the feedback subfield, for example, in case the multi-STA BA frame include the feedback frame, or the length of a BA bitmap subfield, for example, in case the multi-STA BA frame includes the BA bitmap subfield.

In some demonstrative aspects, controller 124 may be configured to control, trigger, cause, and/or instruct the STA implemented by device 102 to set an AID subfield in the per AID TID info field to a predefined AID value, for example, to indicate that the feedback information is intended for all receiving STAs, e.g., as described below.

In some demonstrative aspects, the predefined AID value may be different from 2045.

In some demonstrative aspects, the predefined AID value may be equal to or less than 2044.

In some demonstrative aspects, the predefined AID value may be 2008, e.g., as described below.

In other aspects, the predefined AID value may include any other value to indicate that the feedback information is intended for all receiving STAs.

In some demonstrative aspects, controller 124 may be configured to control, trigger, cause, and/or instruct the STA implemented by device 102 to broadcast the multi-STA BA frame, e.g., as described below.

In some demonstrative aspects, controller 124 may be configured to control, trigger, cause, and/or instruct the STA implemented by device 102 to broadcast the multi-STA BA frame, for example, when the AID subfield in the per AID TID info field is set to the predefined AID value to indicate that the feedback information is intended for all receiving STAs, e.g., as described below.

In some demonstrative aspects, the AID subfield, which may be utilized to indicate that the feedback information is intended for all receiving STAs, may include an AID11 subfield, e.g., as described below.

In other aspects, the AID subfield may include any other additional or alternative type of subfield in the per AID TID info field.

In some demonstrative aspects, controller 124 may be configured to control, trigger, cause, and/or instruct the STA implemented by device 102 to set an AID subfield in the per AID TID info field to an AID of an intended receiver STA for the feedback information, e.g., as described below.

In some demonstrative aspects, controller 124 may be configured to control, trigger, cause, and/or instruct the STA implemented by device 102 to transmit the multi-STA BA frame as a unicast frame addressed to the intended receiver STA, for example, when the AID subfield in the per AID TID info field is set to the AID of the intended receiver STA for the feedback information, e.g., as described below.

In some demonstrative aspects, the AID subfield, which may be utilized to indicate the AID of the intended receiver STA for the feedback information, may include an AID11 subfield, e.g., as described below.

In some demonstrative aspects, controller 124 may be configured to control, trigger, cause, and/or instruct the STA implemented by device 102 to set the feedback information including unavailability information, e.g., as described below.

In some demonstrative aspects, controller 124 may be configured to control, trigger, cause, and/or instruct the STA implemented by device 102 to set the feedback subfield including an unavailability target start time subfield, e.g., as described below.

In some demonstrative aspects, controller 124 may be configured to control, trigger, cause, and/or instruct the STA implemented by device 102 to set the unavailability target start time subfield to indicate a target start time of an unavailability period, e.g., as described below.

In some demonstrative aspects, controller 124 may be configured to control, trigger, cause, and/or instruct the STA implemented by device 102 to set the feedback subfield including an unavailability duration subfield, e.g., as described below.

In some demonstrative aspects, controller 124 may be configured to control, trigger, cause, and/or instruct the STA implemented by device 102 to set the unavailability duration subfield to indicate a duration of the unavailability period, e.g., as described below.

In some demonstrative aspects, controller 124 may be configured to control, trigger, cause, and/or instruct the STA implemented by device 102 to set the feedback subfield including any other additional or alternative unavailability information.

In some demonstrative aspects, controller 124 may be configured to control, trigger, cause, and/or instruct the STA implemented by device 102 to set the feedback information including coexistence information, e.g., as described below.

In some demonstrative aspects, controller 124 may be configured to control, trigger, cause, and/or instruct the STA implemented by device 102 to set the feedback information including link adaptation information, e.g., as described below.

In some demonstrative aspects, controller 124 may be configured to control, trigger, cause, and/or instruct the STA implemented by device 102 to set the feedback information including an indication of a receive status due to interference, e.g., as described below.

In some demonstrative aspects, controller 124 may be configured to control, trigger, cause, and/or instruct the STA implemented by device 102 to set a single bit to indicate the receive status due to interference, e.g., as described below.

In some demonstrative aspects, controller 124 may be configured to control, trigger, cause, and/or instruct the STA implemented by device 102 to set the feedback information including parameter negotiation information, e.g., as described below.

In other aspects, the feedback information may include any other additional or alternative type of information.

In some demonstrative aspects, controller 124 may be configured to control, trigger, cause, and/or instruct the STA implemented by device 102 to set a feedback type subfield in the feedback subfield, for example, to indicate a type of the feedback information, e.g., as described below.

In some demonstrative aspects, controller 124 may be configured to control, trigger, cause, and/or instruct the STA implemented by device 102 to set the feedback type subfield to a selected type value from a plurality of predefined type values, e.g., as described below.

In some demonstrative aspects, the selected type value may be configured to indicate the type of the feedback information, e.g., as described below.

In some demonstrative aspects, the plurality of predefined type values may be configured to correspond to a respective plurality of predefined feedback information types, e.g., as described below.

In some demonstrative aspects, controller 124 may be configured to control, trigger, cause, and/or instruct the STA implemented by device 102 to set a feedback size subfield in the feedback subfield, for example, to indicate a size of the feedback field, e.g., as described below.

In some demonstrative aspects, controller 124 may be configured to control, trigger, cause, and/or instruct the STA implemented by device 102 to set one or more other per AID TID info fields in the multi-STA BA frame as one or more padding fields, e.g., as described below.

In some demonstrative aspects, controller 124 may be configured to control, trigger, cause, and/or instruct the STA implemented by device 102 to set a feedback type subfield in the one or more other per AID TID info fields to a predefined padding type value, for example, to indicate that the one or more other per AID TID info fields are set as the one or more padding fields, e.g., as described below.

In some demonstrative aspects, controller 154 may be configured to control, trigger, cause, and/or instruct a STA implemented by device 140 to process an Ack type subfield in a per AID TID info field in a received multi-STA BA frame, for example, to identify an Ack type subfield and a TID subfield, e.g., as described below.

For example, the multi-STA BA frame received by the STA implemented by device 140 may include the multi-STA BA frame transmitted by the STA implemented by device 102, e.g., as described above.

In some demonstrative aspects, controller 154 may be configured to control, trigger, cause, and/or instruct the STA implemented by device 140 to identify that the per AID TID info field includes feedback information, for example, based on a determination that the Ack type subfield is set to 0 and the TID subfield is set to 13, e.g., as described below.

In other aspects, the Ack type subfield and the TID subfield may include any other combination of values to indicate that the per AID TID info field includes feedback information.

In some demonstrative aspects, controller 154 may be configured to control, trigger, cause, and/or instruct the STA implemented by device 140 to process a feedback subfield in the per AID TID info field, for example, to identify the feedback information, e.g., as described below.

In some demonstrative aspects, controller 154 may be configured to control, trigger, cause, and/or instruct the STA implemented by device 140 to process the feedback information, e.g., as described below.

In some demonstrative aspects, controller 154 may be configured to control, trigger, cause, and/or instruct the STA implemented by device 140 to determine that the per AID TID info field is to include the feedback information instead of ack information, for example, based on the determination that the Ack type subfield is set to 0 and the TID subfield is set to 13, e.g., as described below.

In some demonstrative aspects, controller 154 may be configured to control, trigger, cause, and/or instruct the STA implemented by device 140 to determine that the per AID TID info field is to include the feedback subfield instead of a BA bitmap subfield, for example, based on the determination that the Ack type subfield is set to 0 and the TID subfield is set to 13, e.g., as described below.

In some demonstrative aspects, controller 154 may be configured to control, trigger, cause, and/or instruct the STA implemented by device 140 to process a BA starting sequence control subfield in the per AID TID info field, for example, to determine a length of the feedback subfield, e.g., as described below.

In some demonstrative aspects, controller 154 may be configured to control, trigger, cause, and/or instruct the STA implemented by device 140 to process the BA starting sequence control subfield in the per AID TID info field, for example, to identify a selected length from a plurality of predefined lengths, e.g., as described below.

In some demonstrative aspects, the selected length may be configured to indicate the length of the feedback subfield, e.g., as described below.

In some demonstrative aspects, controller 154 may be configured to control, trigger, cause, and/or instruct the STA implemented by device 140 to process the BA starting sequence control subfield in the per AID TID info field, for example, to determine a length of 4, 8, 16, or 32 octets for the feedback subfield, e.g., as described below.

In other aspects, the feedback subfield may have any other suitable length.

In some demonstrative aspects, controller 154 may be configured to control, trigger, cause, and/or instruct the STA implemented by device 140 to process a fragment number subfield in the BA starting sequence control subfield, for example, to determine the length of the feedback subfield, e.g., as described below.

For example, controller 154 may be configured to control, trigger, cause, and/or instruct the STA implemented by device 140 to determine the length of the feedback subfield based on the fragment number subfield, for example, according to Table 1, e.g., as described above.

In some demonstrative aspects, controller 154 may be configured to control, trigger, cause, and/or instruct the STA implemented by device 140 to process an AID subfield in the per AID TID info field to identify a predefined AID value, for example, to indicate that the feedback information is intended for all receiving STAs, e.g., as described below.

In some demonstrative aspects, the predefined AID value may be 2008, e.g., as described below.

In other aspects, the predefined AID value may include any other value to indicate that the feedback information is intended for all receiving STAs.

In some demonstrative aspects, the multi-STA BA frame, which includes the predefined AID value to indicate that the feedback information is intended for all receiving STAs, may include a broadcast frame, e.g., as described below.

In some demonstrative aspects, the AID subfield, which includes the predefined AID value to indicate that the feedback information is intended for all receiving STAs, may include an AID11 subfield, e.g., as described below.

In some demonstrative aspects, controller 154 may be configured to control, trigger, cause, and/or instruct the STA implemented by device 140 to process an AID subfield in the per AID TID info field, for example, to determine whether the feedback information is intended for the STA, e.g., as described below.

In some demonstrative aspects, controller 154 may be configured to control, trigger, cause, and/or instruct the STA implemented by device 140 to receive the multi-STA BA frame as a unicast frame addressed to the STA, e.g., as described below.

In some demonstrative aspects, the AID subfield, which is to indicate whether the feedback information is intended for the STA, may include an AID11 subfield, e.g., as described below.

In some demonstrative aspects, controller 154 may be configured to control, trigger, cause, and/or instruct the STA implemented by device 140 to process the feedback information, for example, to identify unavailability information, e.g., as described below.

In some demonstrative aspects, controller 154 may be configured to control, trigger, cause, and/or instruct the STA implemented by device 140 to process the feedback subfield, for example, to identify an unavailability target start time subfield, e.g., as described below.

In some demonstrative aspects, controller 154 may be configured to control, trigger, cause, and/or instruct the STA implemented by device 140 to process the unavailability target start time subfield, for example, to identify a target start time of an unavailability period, e.g., as described below.

In some demonstrative aspects, controller 154 may be configured to control, trigger, cause, and/or instruct the STA implemented by device 140 to process the feedback subfield, for example, to identify an unavailability duration subfield, e.g., as described below.

In some demonstrative aspects, controller 154 may be configured to control, trigger, cause, and/or instruct the STA implemented by device 140 to process the unavailability duration subfield, for example, to identify a duration of the unavailability period, e.g., as described below.

In some demonstrative aspects, controller 154 may be configured to control, trigger, cause, and/or instruct the STA implemented by device 140 to process the feedback information, for example, to identify coexistence information, e.g., as described below.

In some demonstrative aspects, controller 154 may be configured to control, trigger, cause, and/or instruct the STA implemented by device 140 to process the feedback information, for example, to identify link adaptation information, e.g., as described below.

In some demonstrative aspects, controller 154 may be configured to control, trigger, cause, and/or instruct the STA implemented by device 140 to process the feedback information, for example, to identify an indication of a receive status due to interference, e.g., as described below.

In some demonstrative aspects, controller 154 may be configured to control, trigger, cause, and/or instruct the STA implemented by device 140 to process a single bit to indicate the receive status due to interference, e.g., as described below.

In some demonstrative aspects, controller 154 may be configured to control, trigger, cause, and/or instruct the STA implemented by device 140 to process the feedback information, for example, to identify parameter negotiation information, e.g., as described below.

In other aspects, controller 154 may be configured to control, trigger, cause, and/or instruct the STA implemented by device 140 to process the feedback information to identify any other additional or alternative type of information.

In some demonstrative aspects, controller 154 may be configured to control, trigger, cause, and/or instruct the STA implemented by device 140 to process a feedback type subfield in the feedback subfield, for example, to identify a type of the feedback information, e.g., as described below.

In some demonstrative aspects, controller 154 may be configured to control, trigger, cause, and/or instruct the STA implemented by device 140 to process the feedback type subfield, for example, to identify a selected type value from a plurality of predefined type values, e.g., as described below.

In some demonstrative aspects, the selected type value may be configured to indicate the type of the feedback information, e.g., as described below.

In some demonstrative aspects, the plurality of predefined type values may be configured to correspond to a respective plurality of predefined feedback information types, e.g., as described below.

In some demonstrative aspects, controller 154 may be configured to control, trigger, cause, and/or instruct the STA implemented by device 140 to process a feedback size subfield in the feedback subfield, for example, to identify a size of the feedback field, e.g., as described below.

In some demonstrative aspects, controller 154 may be configured to control, trigger, cause, and/or instruct the STA implemented by device 140 to determine that one or more other per AID TID info fields in the multi-STA BA frame are one or more padding fields, e.g., as described below.

In some demonstrative aspects, controller 154 may be configured to control, trigger, cause, and/or instruct the STA implemented by device 140 to process a feedback type subfield in the one or more other per AID TID info fields, for example, to identify a predefined padding type value to indicate that the one or more other per AID TID info fields are set as the one or more padding fields, e.g., as described below.

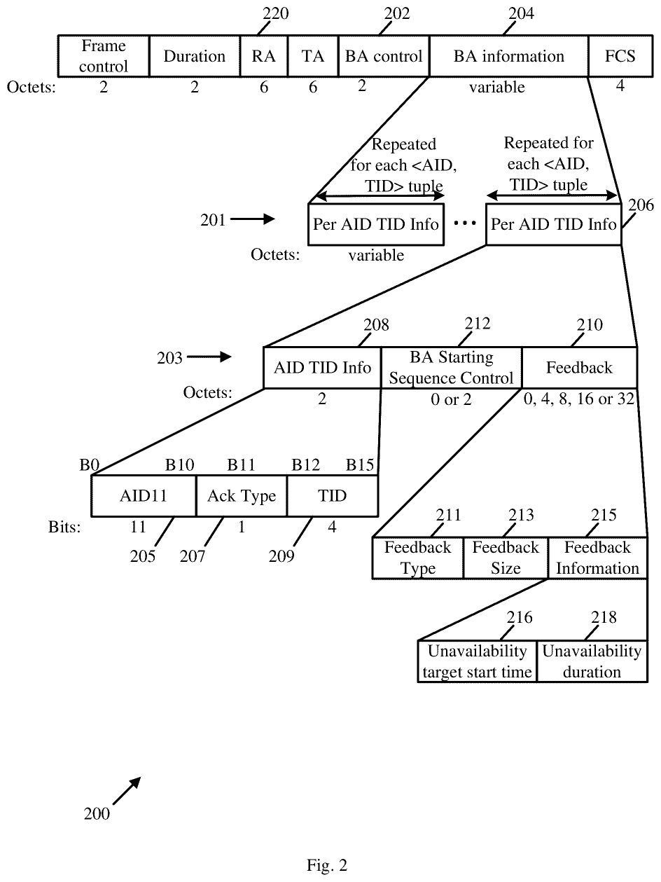

Reference is made to FIG. 2, which schematically illustrates a multi-STA BA frame 200, in accordance with some demonstrative aspects.

In some demonstrative aspects, device 102 (FIG. 1), device 140 (FIG. 1) and/or device 160 (FIG. 1) may be configured to generate, transmit, receive, and/or process multi-STA BA frame 200.

In some demonstrative aspects, as shown in FIG. 2, multi-STA BA frame 200 may include a BA control field 202, which may include a BA type field set to a predefined value, e.g., 11, to indicate that frame 200 is a multi-BA frame.

In some demonstrative aspects, as shown in FIG. 2, multi-STA BA frame 200 may include a BA information field 204, e.g., as described below.

In some demonstrative aspects, as shown in FIG. 2, BA information field 204 may include one or more per AID TID info fields 201.

In some demonstrative aspects, as shown in FIG. 2, a per AID TID info field 206 of the one or more per AID TID info fields 201 may be configured according to a per AID TID field format 203, e.g., as described below. For example, the per AID TID info field 206 may be configured to carry feedback information.

In some demonstrative aspects, as shown in FIG. 2, per AID TID info field 206 may include an AID TID info subfield 208, for example, at the beginning of per AID TID info field 206.

In some demonstrative aspects, as shown in FIG. 2, AID TID info subfield 208 may include an ack type subfield 207. For example, as shown in FIG. 2, ack type subfield 207 may have a size of one bit.

In some demonstrative aspects, as shown in FIG. 2, AID TID info subfield 208 may include a TID subfield 209. For example, as shown in FIG. 2, TID subfield 209 may have a size of 4 bits.

In some demonstrative aspects, ack type subfield 207 may be set to 0 and TID subfield may be set to 13, for example, to indicate that per AID TID info field 206 includes feedback information.

In some demonstrative aspects, ack type subfield 207 may be set to 0 and TID subfield may be set to 13, for example, to indicate that per AID TID info field 206 includes feedback information, for example, instead of ack information.

In some demonstrative aspects, ack type subfield 207 may be set to 0 and TID subfield may be set to 13, for example, to indicate that per AID TID info field 206 includes a feedback subfield, for example, instead of a BA bitmap subfield.

In other aspects, ack type subfield 207 and TID subfield may be set to any other predefined combination of values to indicate that per AID TID info field 206 includes feedback information.

In some demonstrative aspects, as shown in FIG. 2, AID TID info subfield 208 may include an AID11 subfield 205. For example, as shown in FIG. 2, AID11 subfield 205 may have a size of 11 bits.

In some demonstrative aspects, AID11 subfield 205 may be set to a predefined value, e.g., 2008 or any other predefined value, for example, to indicate that the multi-STA BA frame 200 includes feedback information for multiple STAs. For example, multi-STA BA frame 200 may be broadcasted, e.g., when AID11 subfield 205 is set to 2008.

In some demonstrative aspects, AID11 subfield 205 may be set to an AID of a particular STA, for example, to indicate that the multi-STA BA frame 200 includes feedback information for that particular STA. For example, multi-STA BA frame 200 may be unicast, e.g., when AID11 subfield 205 is set to the AID of the particular STA. For example, the particular STA may be identified as the STA addressed in a Receiver Address (RA) field 220 of the multi-STA BA frame 200.

In some demonstrative aspects, as shown in FIG. 2, per AID TID info field 206 may include a BA starting sequence control subfield 212, which may be configured to indicate a length of a feedback subfield 210.

For example, BA starting sequence control subfield 212 may be set to indicate the length of feedback subfield 210 according to Table 1, e.g., as described above.

In some demonstrative aspects, as shown in FIG. 2, per AID TID info field 206 may include the feedback subfield 210, which may be configured to include feedback information.

In some demonstrative aspects, feedback subfield 210 may have a length of 0, 4, 8, 16, or 32 octets. In other aspects, feedback subfield 210 may have any other length.

In some demonstrative aspects, feedback subfield 210 may be configured to include a feedback type subfield 211, for example, to indicate a type of the feedback information, e.g., as describe below.

In some demonstrative aspects, feedback subfield 210 may be configured to include a feedback size subfield 213, for example, to indicate a size of the feedback information in the feedback subfield 210.

In some demonstrative aspects, feedback subfield 210 may be configured to include a feedback information subfield 215, which may be configured to include the feedback information.

In some demonstrative aspects, feedback information subfield 215 may be configured to include unavailability information, e.g., as described below.

In some demonstrative aspects, feedback information subfield 215 may be configured to include an unavailability target start time subfield 216, for example, to indicate a target start time of an unavailability period.

In some demonstrative aspects, feedback information subfield 215 may be configured to include an unavailability duration subfield 218, for example, to indicate a duration of the unavailability period.

In other aspects, feedback information subfield 215 may be configured to include any other additional or alternative information, e.g., as described above.

Referring back to FIG. 1, in some demonstrative aspects, device 102, device 140, and/or device 160 may be configured to implement one or more operations and/or functionalities of a feedback mechanism, which may be configured to support communicating a multi-STA BA frame including feedback information, e.g., as described below.

In some demonstrative aspects, device 102, device 140, and/or device 160 may be configured to implement one or more operations and/or functionalities of a first feedback mechanism, which may be configured to provide a technical solution to support communicating a multi-STA BA frame as a unicast frame, for example, when feedback information is intended for a particular STA, e.g., as described below.

In some demonstrative aspects, the first feedback mechanism may be configured to provide a technical solution to support broadcasting a multi-STA BA frame, for example, when the same feedback information is intended for a plurality of, e.g., all, receivers, e.g., as described below.

In some demonstrative aspects, it may be defined, e.g., according to the first feedback mechanism, that a multi-STA BA frame is to be configured to include a per AID TID info field, e.g., a special (feedback) per AID TID info field, which may be set with a predefined, e.g., special, AID value dedicated to feedbacks, e.g., as described below.

In some demonstrative aspects, it may be defined, e.g., according to the first feedback mechanism, that a per AID TID info field is to include an AID11 field set to a predefined, e.g., special, AID value to indicate that the per AID TID info field is a special (feedback) AID TID info field dedicated to feedbacks.

In one example, it may be defined that the predefined AID value is 2008.

In another example, it may be defined that the predefined AID value is 2044.

In other aspects, any other predefined AID value may be used to indicate that the AID TID info field includes feedback information.

In some demonstrative aspects, it may be defined, that an Ack type subfield of a per AID TID info field is to be set to 0, and a TID subfield of a per AID TID info field is to be set to 13, for example, to indicate that the per AID TID info field is to include feedback information, e.g., as described below.

In some demonstrative aspects, the TID subfield may be set to any other value, for example, to a value between 8 and 13, or any other suitable value.

In some demonstrative aspects, it may be defined that the Ack type subfield is to be set to 0, for example, to indicate that a size of a BA Bitmap is set by a fragment number subfield in a BA Starting Sequence Control (SSC) subfield.

In some demonstrative aspects, the size of the BA Bitmap indicated in the BA SSC subfield within the special (feedback) per AID TID Info field may be parameterized, for example, in case there are multiple feedbacks, e.g., as described below.

In some demonstrative aspects, the BA SSC subfield in the special (feedback) per AID TID Info field, may be utilized, for example, to indicate the size of the feedback information, for example, according to Table 1, e.g., as described above.

In some demonstrative aspects, the fragment number subfield in the BA SSC subfield may be set according to the definition for the BA Bitmap size, e.g., to 0, 4, 8, 16, or 32 bytes, for example, according to Table 1, e.g., to indicate the size of the feedback information.

In some demonstrative aspects, it may be defined that the fragment number subfield in the BA SSC subfield is to be set to a selected size of BA Bitmap, for example, such that the selected size of BA Bitmap is equal to or larger than the size of the feedbacks to be included in the special (feedback) per AID TID Info field.

In some demonstrative aspects, it may be defined that a multi-STA BA frame may include two or more back-to-back special (feedback) per AID TID info fields, for example, to include all the feedbacks, for example, in case the size of BA Bitmap is not enough.

In some demonstrative aspects, the first feedback mechanism may be configured to support structuring the BA Bitmap with one or more feedback subfields (also referred to as “per feedback Info subfields”), e.g., as described below.

In some demonstrative aspects, a feedback subfield may be configured according to a generic structure, e.g., as described below.

In some demonstrative aspects, the feedback subfield may include a feedback type subfield that is set to a value corresponding to a feedback type.

In one example, the feedback type subfield may be set to 0, for example, to indicate that the feedback subfield includes coexistence information.

In another example, the feedback type subfield may be set to 1, for example, to indicate that the feedback subfield includes link adaptation information.

In another example, the feedback type subfield may be set to any other additional or alternative value to indicate any other feedback type.

In some demonstrative aspects, the feedback subfield may include, e.g., optionally, a feedback size subfield, for example, to define a size of the feedback subfield, e.g., unless the size is known or predefined by the feedback type subfield value.

In some demonstrative aspects, the feedback subfield may include one or more subfields to include the feedback information.

In some demonstrative aspects, the feedback subfield may include one or more subfields, which may be configured, for example, based on the type of feedback.

In some demonstrative aspects, the feedback subfield may include coexistence information.

In some demonstrative aspects, the feedback subfield may include unavailability information.

For example, in case the feedback information includes coexistence information, e.g., unavailability information, the feedback subfield may include an unavailability target start time subfield, e.g., to indicate a target start time of an unavailability period.

For example, in case the feedback information includes coexistence information, e.g., unavailability information, the feedback subfield may include an unavailability duration subfield, e.g., to indicate a duration of the unavailability period.

In some demonstrative aspects, a BA Bitmap, which is utilized as the special (feedback) per AID TID info field, may be configured to be completed with padding, for example, as the size of one or more, e.g., all, feedback subfields that are included in the special (feedback) per AID TID info field may not match all the time the size of the BA Bitmap.

In some demonstrative aspects, a predefined value (“padding value”) may be set, e.g., in a feedback type field in a particular feedback subfield, for example, to indicate that the particular feedback subfield is configured as a padding subfield.

In one example, the padding value may be “1111”. In other aspects, any other suitable padding value may be defined.

In some demonstrative aspects, it may be defined that the padding subfield is to have a fixed size, for example, 1 Byte or more, e.g. including the feedback type subfield and one or more padding subfields that are included to fill the BA Bitmap, for example, when the type subfield in the particular feedback subfield is set to the padding value.

In some demonstrative aspects, device 102, device 140, and/or device 160 may be configured to implement one or more operations and/or functionalities of a second feedback mechanism, which may be configured to provide a technical solution to support broadcasting a multi-STA BA frame including different feedbacks for different intended receivers, e.g., as described below.

In some demonstrative aspects, device 102, device 140, and/or device 160 may be configured to implement one or more operations and/or functionalities of the second feedback mechanism, which may be configured to provide a technical solution to support communicating a multi-STA BA frame as a unicast frame, e.g., as described below.

In some demonstrative aspects, device 102, device 140, and/or device 160 may be configured to implement one or more operations and/or functionalities of the second feedback mechanism, which may be configured to support communicating a multi-STA BA frame for just one intended receiver.

In some demonstrative aspects, device 102, device 140, and/or device 160 may be configured to implement one or more operations and/or functionalities of the second feedback mechanism, which may be configured to support communicating a multi-STA BA frame including the same feedback for all intended receivers.

In some demonstrative aspects, it may be defined, e.g., according the second feedback mechanism, that a per AID TID Info field is to be configured as a per AID Feedback Info field, which may be configured, for example, to include a specific setting of Ack Type and TID subfields, e.g., as described below.

In some demonstrative aspects, it may be defined that an Ack Type subfield and a TID subfield in the per AID TID Info field may be set to a predefined combination of values to indicate that the per AID TID Info field includes feedback information.

For example, the Ack Type subfield may be set to 0 and the TID subfield may be set to 13 or any other predefined combination, for example, to indicate that the Per AID TID Info field includes feedback information.

For example, the TID subfield may be set to any value between 8 and 13.

In some demonstrative aspects, an AID11 field of the Per AID TID Info field may be set to an AID value of a particular STA, for example, to indicate that the Per AID TID Info field includes feedback dedicated to the particular STA.

In some demonstrative aspects, it may be defined that the Ack type subfield is to be set to 0, for example, to indicate that a size of a BA Bitmap is set by a fragment number subfield in a BA Starting Sequence Control (SSC) subfield.

In some demonstrative aspects, the size of the BA Bitmap indicated in the BA SSC subfield within the special (feedback) per AID TID Info field may be parameterized, for example, in case there are multiple feedbacks, e.g., as described below.

In some demonstrative aspects, the BA SSC subfield in the special (feedback) per AID TID Info field, may be utilized, for example, to indicate the size of the feedback information, for example, according to Table 1, e.g., as described above.

In some demonstrative aspects, the fragment number subfield in the BA SSC subfield may be set according to the definition for the BA Bitmap size, e.g., to 0, 4, 8, 16, or 32 bytes, for example, according to Table 1, e.g., to indicate the size of the feedback information.

In some demonstrative aspects, it may be defined that the fragment number subfield in the BA SSC subfield is to be set to a selected size of BA Bitmap, for example, such that the selected size of BA Bitmap is equal to or larger than the size of the feedbacks to be included in the special (feedback) per AID TID Info field.

In some demonstrative aspects, it may be defined that a multi-STA BA frame may include two or more back-to-back special (feedback) per AID TID info fields, for example, to include all the feedbacks, for example, in case the size of BA Bitmap is not enough.

In some demonstrative aspects, the second feedback mechanism may be configured to support structuring the BA Bitmap with one or more feedback subfields (also referred to as “per feedback Info subfields”), e.g., as described below.

In some demonstrative aspects, a feedback subfield may be configured according to a generic structure, e.g., as described below.

In some demonstrative aspects, the feedback subfield may include a feedback type subfield that is set to a value corresponding to a feedback type.

In one example, the feedback type subfield may be set to 0, for example, to indicate that the feedback subfield includes coexistence information.

In another example, the feedback type subfield may be set to 1, for example, to indicate that the feedback subfield includes link adaptation information.

In another example, the feedback type subfield may be set to any other additional or alternative value to indicate any other feedback type.

In some demonstrative aspects, the feedback subfield may include, e.g., optionally, a feedback size subfield, for example, to define a size of the feedback subfield, e.g., unless the size is known or predefined by the feedback type subfield value.

In some demonstrative aspects, the feedback subfield may include one or more subfields to include the feedback information.

In some demonstrative aspects, the feedback subfield may include one or more subfields, which may be configured, for example, based on the type of feedback.

In some demonstrative aspects, the feedback subfield may include coexistence information.

In some demonstrative aspects, the feedback subfield may include unavailability information.

For example, in case the feedback information includes coexistence information, e.g., unavailability information, the feedback subfield may include an unavailability target start time subfield, e.g., to indicate a target start time of an unavailability period.

For example, in case the feedback information includes coexistence information, e.g., unavailability information, the feedback subfield may include an unavailability duration subfield, e.g., to indicate a duration of the unavailability period.

In some demonstrative aspects, a BA Bitmap, which is utilized as the special (feedback) per AID TID info field, may be configured to be completed with padding, for example, as the size of one or more, e.g., all, feedback subfields that are included in the special (feedback) per AID TID info field may not match all the time the size of the BA Bitmap.

In some demonstrative aspects, a predefined value (“padding value”) may be set, e.g., in a feedback type field in a particular feedback subfield, for example, to indicate that the particular feedback subfield is configured as a padding subfield.

In one example, the padding value may be “1111”. In other aspects, any other suitable padding value may be defined.

In some demonstrative aspects, it may be defined that the padding subfield is to have a fixed size, for example, 1 Byte or more, e.g. including the feedback type subfield and one or more padding subfields that are included to fill the BA Bitmap, for example, when the type subfield in the particular feedback subfield is set to the padding value.

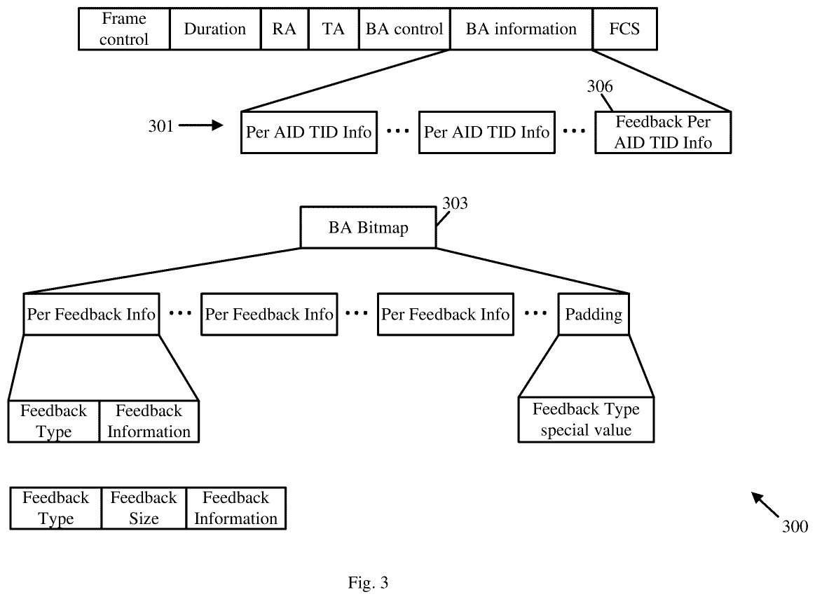

Reference is made to FIG. 3, which schematically illustrates a multi-STA BA frame 300, in accordance with some demonstrative aspects.

In some demonstrative aspects, device 102 (FIG. 1), device 140 (FIG. 1) and/or device 160 (FIG. 1) may be configured to generate, transmit, receive, and/or process multi-STA BA frame 300.

In some demonstrative aspects, as shown in FIG. 3, the multi-STA BA frame 300 may include a plurality of per AID TID info fields 301 including feedback information.

In some demonstrative aspects, multi-STA BA frame 300 may be configured according to a first feedback mechanism, for example, as a unicast frame or broadcast frame including same feedback information for all intended receivers, e.g., as described above.

In some demonstrative aspects, it may be defined, e.g., according to the first feedback mechanism, that an AID subfield in a per AID TID info field 306 of the plurality of per AID TID info fields 301 may be configured to include feedback information, e.g., as described above.

In some demonstrative aspects, the per AID TID info field may include an Ack type subfield, e.g., Ack type subfield 207 (FIG. 2), set to 0, and a TID subfield, e.g., TID subfield 209 (FIG. 2), set to 13, for example, to indicate that the per AID TID info field 306 includes feedback information, e.g., as described above.

In some demonstrative aspects, the AID subfield may include an AID11 subfield, e.g., AID11 subfield 205 (FIG. 2), set to a predefined value, e.g., the value 2008, to indicate that the feedback information is intended for all receiving STAs, e.g., as described above.

In some demonstrative aspects, a BA SSC subfield in the per AID TID info field, e.g., BA SSC subfield 212 (FIG. 2), may be configured to indicate a length of the feedback subfield.

In some demonstrative aspects, a size of a BA Bitmap subfield 303 may be defined by a fragment number field in the BA SSC subfield, for example, according to Table 1, e.g., as described above.

In some demonstrative aspects, the per AID TID info field 306 may include an Ack type subfield set to 0, for example, to indicate that a size of a BA Bitmap subfield 303 is set by a fragment number field in the BA SSC subfield, e.g., as described above.

In some demonstrative aspects, the BA Bitmap subfield 303 may include one or more per AID TID info fields including feedback information, e.g., as described above.

In some demonstrative aspects, the BA Bitmap subfield 303 may include one or more other per AID TID info fields set as one or more padding fields, e.g., as described above.

In some demonstrative aspects, multi-STA BA frame 300 may be configured according to a second feedback mechanism, for example, as a broadcast frame including different feedback information for different intended receivers, e.g., as described above.

In some demonstrative aspects, the AID subfield may include an AID11 subfield, e.g., AID11 subfield 205 (FIG. 2), set to an AID of a particular STA to which feedback in intended.

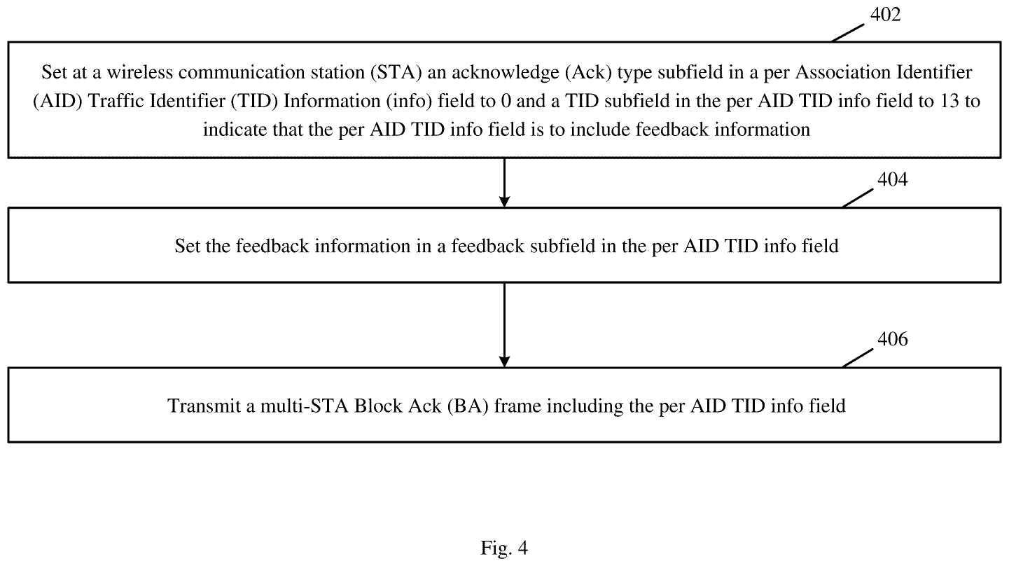

Reference is made to FIG. 4, which schematically illustrates a method of communicating feedback information in a multi-STA BA frame, in accordance with some demonstrative aspects. For example, one or more of the operations of the method of FIG. 4 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 402, the method may include setting at a STA an Ack type subfield in a per AID TID info field to 0 and a TID subfield in the per AID TID info field to 13, for example, to indicate that the per AID TID info field is to include feedback information. For example, controller 124 (FIG. 1) may be configured to cause, trigger, and/or control the STA implemented by device 102 (FIG. 1) to set the Ack type subfield in the per AID TID info field to 0 and the TID subfield in the per AID TID info field to 13, for example, to indicate that the per AID TID info field is to include the feedback information, e.g., as described above.

As indicated at block 404, the method may include setting the feedback information in a feedback subfield in the per AID TID info field. For example, controller 124 (FIG. 1) may be configured to cause, trigger, and/or control the STA implemented by device 102 (FIG. 1) to set the feedback information in the feedback subfield in the per AID TID info field, e.g., as described above.

As indicated at block 406, the method may include transmitting a multi-STA BA frame including the per AID TID info field. For example, controller 124 (FIG. 1) may be configured to cause, trigger, and/or control the STA implemented by device 102 (FIG. 1) to transmit the multi-STA BA frame including the per AID TID info field, e.g., as described above.

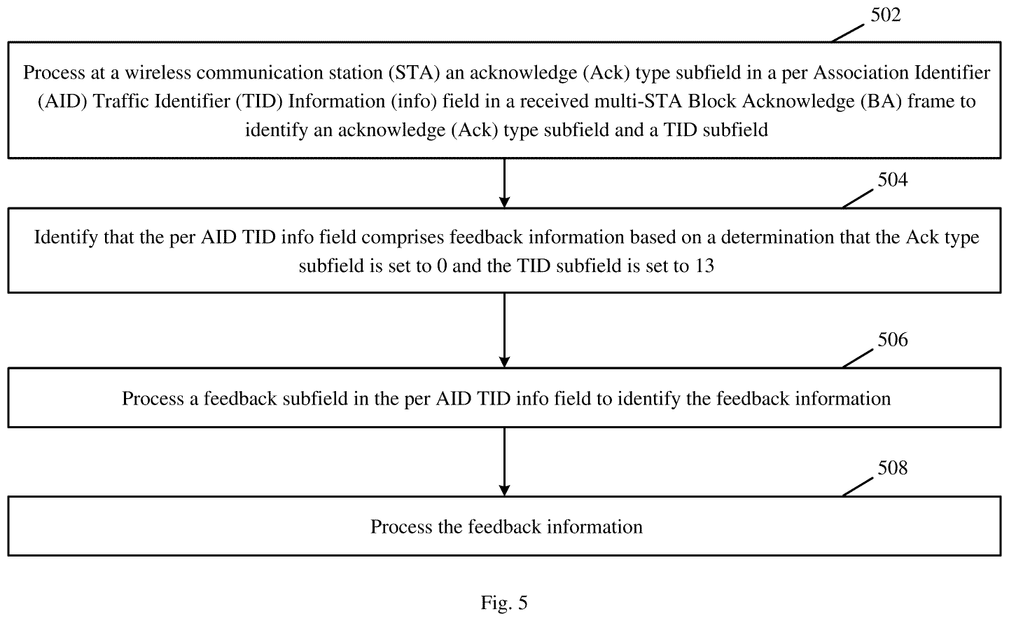

Reference is made to FIG. 5, which schematically illustrates a method of communicating feedback information in a multi-STA BA frame, in accordance with some demonstrative aspects. For example, one or more of the operations of the method of FIG. 5 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 502, the method may include processing at a STA an Ack type subfield in a per AID TID info field in a received multi-STA BA frame, for example, to identify an Ack type subfield and a TID subfield. For example, controller 154 (FIG. 1) may be configured to cause, trigger, and/or control the STA implemented by device 140 (FIG. 1) to process the Ack type subfield in the per AID TID info field in the received multi-STA BA frame to identify the Ack type subfield and the TID subfield, e.g., as described above.

As indicated at block 504, the method may include identifying that the per AID TID info field includes feedback information, for example, based on a determination that the Ack type subfield is set to 0 and the TID subfield is set to 13. For example, controller 154 (FIG. 1) may be configured to cause, trigger, and/or control the STA implemented by device 140 (FIG. 1) to identify that the per AID TID info field includes the feedback information, for example, based on a determination that the Ack type subfield is set to 0 and the TID subfield is set to 13, e.g., as described above.

As indicated at block 506, the method may include processing a feedback subfield in the per AID TID info field to identify the feedback information. For example, controller 154 (FIG. 1) may be configured to cause, trigger, and/or control the STA implemented by device 140 (FIG. 1) to process the feedback subfield in the per AID TID info field to identify the feedback information, e.g., as described above.

As indicated at block 508, the method may include processing the feedback information. For example, controller 154 (FIG. 1) may be configured to cause, trigger, and/or control the STA implemented by device 140 (FIG. 1) to process the feedback information, e.g., as described above.

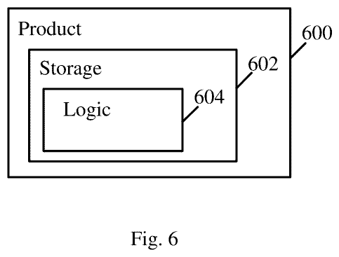

Reference is made to FIG. 6, which schematically illustrates a product of manufacture 600, in accordance with some demonstrative aspects. Product 600 may include one or more tangible computer-readable (“machine-readable”) non-transitory storage media 602, which may include computer-executable instructions, e.g., implemented by logic 604, operable to, when executed by at least one computer processor, enable the at least one computer processor to implement one or more operations at device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1-5, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 600 and/or machine readable storage media 602 may include one or more types of computer-readable storage media capable of storing data, including volatile memory, non-volatile memory, removable or non-removable memory, erasable or non-erasable memory, writeable or re-writeable memory, and the like. For example, machine readable storage media 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### Examples

The following examples pertain to further aspects.

Example 1 includes an apparatus comprising a processor configured to cause a wireless communication station (STA) to set an acknowledge (Ack) type subfield in a per Association Identifier (AID) Traffic Identifier (TID) Information (info) field to 0 and a TID subfield in the per AID TID info field to 13 to indicate that the per AID TID info field is to include feedback information; set the feedback information in a feedback subfield in the per AID TID info field; and transmit a multi-STA Block Ack (BA) frame comprising the per AID TID info field; and a memory to store information processed by the processor.

Example 2 includes the subject matter of Example 1, and optionally, wherein the apparatus is configured to cause the STA to set a BA starting sequence control subfield in the per AID TID info field to indicate a length of the feedback subfield.

Example 3 includes the subject matter of Example 2, and optionally, wherein the apparatus is configured to cause the STA to set the BA starting sequence control subfield in the per AID TID info field to indicate a selected length from a plurality of predefined lengths, the selected length based on the length of the feedback subfield.

Example 4 includes the subject matter of Example 2 or 3, and optionally, wherein the apparatus is configured to cause the STA to set the BA starting sequence control subfield in the per AID TID info field to indicate a length of 4, 8, 16, or 32 octets based on the length of the feedback subfield.

Example 5 includes the subject matter of any one of Examples 2-4, and optionally, wherein the apparatus is configured to cause the STA to set a fragment number subfield in the BA starting sequence control subfield to indicate the length of the feedback subfield.

Example 6 includes the subject matter of any one of Examples 1-5, and optionally, wherein the apparatus is configured to cause the STA to set an AID subfield in the per AID TID info field to a predefined AID value to indicate that the feedback information is intended for all receiving STAs.

Example 7 includes the subject matter of Example 6, and optionally, wherein the predefined AID value is 2008.

Example 8 includes the subject matter of Example 6 or 7, and optionally, wherein the apparatus is configured to cause the STA to broadcast the multi-STA BA frame.

Example 9 includes the subject matter of any one of Examples 6-8, and optionally, wherein the AID subfield comprises an AID11 subfield.

Example 10 includes the subject matter of any one of Examples 1-9, and optionally, wherein the apparatus is configured to cause the STA to set an AID subfield in the per AID TID info field to an AID of an intended receiver STA for the feedback information.

Example 11 includes the subject matter of Example 10, and optionally, wherein the apparatus is configured to cause the STA to transmit the multi-STA BA frame as a unicast frame addressed to the intended receiver STA.

Example 12 includes the subject matter of Example 9 or 10, and optionally, wherein the AID subfield comprises an AID11 subfield.

Example 13 includes the subject matter of any one of Examples 1-12, and optionally, wherein the apparatus is configured to cause the STA to set the feedback information comprising unavailability information.

Example 14 includes the subject matter of any one of Examples 1-13, and optionally, wherein the apparatus is configured to cause the STA to set the feedback subfield comprising an unavailability target start time subfield, and an unavailability duration subfield.

Example 15 includes the subject matter of Example 14, and optionally, wherein the apparatus is configured to cause the STA to set the unavailability target start time subfield to indicate a target start time of an unavailability period, and to set the unavailability duration subfield to indicate a duration of the unavailability period.

Example 16 includes the subject matter of any one of Examples 1-15, and optionally, wherein the apparatus is configured to cause the STA to set the feedback information comprising coexistence information.

Example 17 includes the subject matter of any one of Examples 1-16, and optionally, wherein the apparatus is configured to cause the STA to set the feedback information comprising link adaptation information.

Example 18 includes the subject matter of any one of Examples 1-17, and optionally, wherein the apparatus is configured to cause the STA to set the feedback information comprising an indication of a receive status due to interference.

Example 19 includes the subject matter of Example 18, and optionally, wherein the apparatus is configured to cause the STA to set a single bit to indicate the receive status due to interference.

Example 20 includes the subject matter of any one of Examples 1-19, and optionally, wherein the apparatus is configured to cause the STA to set the feedback information comprising parameter negotiation information.

Example 21 includes the subject matter of any one of Examples 1-20, and optionally, wherein the apparatus is configured to cause the STA to set a feedback type subfield in the feedback subfield to indicate a type of the feedback information.

Example 22 includes the subject matter of Example 21, and optionally, wherein the apparatus is configured to cause the STA to set the feedback type subfield to a selected type value from a plurality of predefined type values, wherein the selected type value is to indicate the type of the feedback information, the plurality of predefined type values corresponding to a respective plurality of predefined feedback information types.

Example 23 includes the subject matter of any one of Examples 1-22, and optionally, wherein the apparatus is configured to cause the STA to set a feedback size subfield in the feedback subfield to indicate a size of the feedback subfield.

Example 24 includes the subject matter of any one of Examples 1-23, and optionally, wherein the apparatus is configured to cause the STA to set one or more other per AID TID info fields in the multi-STA BA frame as one or more padding fields.

Example 25 includes the subject matter of Example 24, and optionally, wherein the apparatus is configured to cause the STA to set a feedback type subfield in the one or more other per AID TID info fields to a predefined padding type value to indicate that the one or more other per AID TID info fields are set as the one or more padding fields.

Example 26 includes the subject matter of any one of Examples 1-25, and optionally, wherein the apparatus is configured to cause the STA to set the Ack type subfield of the per AID TID info field to 0 and the TID subfield of the per AID TID info field to 13 to indicate that the per AID TID info field is to include the feedback information instead of ack information.

Example 27 includes the subject matter of any one of Examples 1-26, and optionally, wherein the apparatus is configured to cause the STA to set the Ack type subfield of the per AID TID info field to 0 and the TID subfield of the per AID TID info field to 13 to indicate that the per AID TID info field is to include the feedback subfield instead of a BA bitmap subfield.

Example 28 includes the subject matter of any one of Examples 1-27, and optionally, wherein the STA comprises a non Access Point (non-AP) STA.

Example 29 includes the subject matter of any one of Examples 1-27, and optionally, wherein the STA comprises an Access Point (AP) STA.

Example 30 includes the subject matter of any one of Examples 1-29, and optionally, wherein the STA comprises an Ultra High Reliability (UHR) STA.

Example 31 includes the subject matter of any one of Examples 1-30, and optionally, comprising a radio to transmit the multi-STA BA frame.

Example 32 includes the subject matter of Example 31, and optionally, comprising one or more antennas connected to the radio, and another processor to execute instructions of an operating system.

Example 33 includes an apparatus comprising a processor configured to cause a wireless communication station (STA) to process an acknowledge (Ack) type subfield in a per Association Identifier (AID) Traffic Identifier (TID) Information (info) field in a received multi-STA Block Acknowledge (BA) frame to identify an acknowledge (Ack) type subfield and a TID subfield; identify that the per AID TID info field comprises feedback information based on a determination that the Ack type subfield is set to 0 and the TID subfield is set to 13; process a feedback subfield in the per AID TID info field to identify the feedback information; and process the feedback information; and a memory to store information processed by the processor.

Example 34 includes the subject matter of Example 33, and optionally, wherein the apparatus is configured to cause the STA to process a BA starting sequence control subfield in the per AID TID info field to determine a length of the feedback subfield.

Example 35 includes the subject matter of Example 34, and optionally, wherein the apparatus is configured to cause the STA to process the BA starting sequence control subfield in the per AID TID info field to identify a selected length from a plurality of predefined lengths, the selected length to indicate the length of the feedback subfield.

Example 36 includes the subject matter of Example 34 or 35, and optionally, wherein the apparatus is configured to cause the STA to process the BA starting sequence control subfield in the per AID TID info field to determine a length of 4, 8, 16, or 32 octets for the feedback subfield.

Example 37 includes the subject matter of any one of Examples 34-36, and optionally, wherein the apparatus is configured to cause the STA to process a fragment number subfield in the BA starting sequence control subfield to determine the length of the feedback subfield.

Example 38 includes the subject matter of any one of Examples 33-37, and optionally, wherein the apparatus is configured to cause the STA to process an AID subfield in the per AID TID info field to identify a predefined AID value to indicate that the feedback information is intended for all receiving STAs.

Example 39 includes the subject matter of Example 38, and optionally, wherein the predefined AID value is 2008.

Example 40 includes the subject matter of Example 38 or 39, and optionally, wherein the multi-STA BA frame is a broadcast frame.

Example 41 includes the subject matter of any one of Examples 38-40, and optionally, wherein the AID subfield comprises an AID11 subfield.

Example 42 includes the subject matter of any one of Examples 33-41, and optionally, wherein the apparatus is configured to cause the STA to process an AID subfield in the per AID TID info field to determine whether the feedback information is intended for the STA.

Example 43 includes the subject matter of Example 42, and optionally, wherein the apparatus is configured to cause the STA to receive the multi-STA BA frame as a unicast frame addressed to the STA.

Example 44 includes the subject matter of Example 42 or 43, and optionally, wherein the AID subfield comprises an AID11 subfield.

Example 45 includes the subject matter of any one of Examples 33-44, and optionally, wherein the apparatus is configured to cause the STA to process the feedback information to identify unavailability information.

Example 46 includes the subject matter of any one of Examples 33-45, and optionally, wherein the apparatus is configured to cause the STA to process the feedback subfield to identify an unavailability target start time subfield, and an unavailability duration subfield.

Example 47 includes the subject matter of Example 46, and optionally, wherein the apparatus is configured to cause the STA to process the unavailability target start time subfield to identify a target start time of an unavailability period, and to process the unavailability duration subfield to identify a duration of the unavailability period.

Example 48 includes the subject matter of any one of Examples 33-47, and optionally, wherein the apparatus is configured to cause the STA to process the feedback information to identify coexistence information.

Example 49 includes the subject matter of any one of Examples 33-48, and optionally, wherein the apparatus is configured to cause the STA to process the feedback information to identify link adaptation information.

Example 50 includes the subject matter of any one of Examples 33-49, and optionally, wherein the apparatus is configured to cause the STA to process the feedback information to identify an indication of a receive status due to interference.

Example 51 includes the subject matter of Example 50, and optionally, wherein the apparatus is configured to cause the STA to process a single bit to indicate the receive status due to interference.

Example 52 includes the subject matter of any one of Examples 33-51, and optionally, wherein the apparatus is configured to cause the STA to process the feedback information to identify parameter negotiation information.

Example 53 includes the subject matter of any one of Examples 33-52, and optionally, wherein the apparatus is configured to cause the STA to process a feedback type subfield in the feedback subfield to identify a type of the feedback information.

Example 54 includes the subject matter of Example 53, and optionally, wherein the apparatus is configured to cause the STA to process the feedback type subfield to identify a selected type value from a plurality of predefined type values, wherein the selected type value is to indicate the type of the feedback information, the plurality of predefined type values corresponding to a respective plurality of predefined feedback information types.

Example 55 includes the subject matter of any one of Examples 33-54, and optionally, wherein the apparatus is configured to cause the STA to process a feedback size subfield in the feedback subfield to identify a size of the feedback subfield.

Example 56 includes the subject matter of any one of Examples 33-55, and optionally, wherein the apparatus is configured to cause the STA to determine that one or more other per AID TID info fields in the multi-STA BA frame are one or more padding fields.

Example 57 includes the subject matter of Example 56, and optionally, wherein the apparatus is configured to cause the STA to process a feedback type subfield in the one or more other per AID TID info fields to identify a predefined padding type value to indicate that the one or more other per AID TID info fields are set as the one or more padding fields.

Example 58 includes the subject matter of any one of Examples 33-57, and optionally, wherein the apparatus is configured to cause the STA to determine that the per AID TID info field is to include the feedback information instead of ack information based on the determination that the Ack type subfield is set to 0 and the TID subfield is set to 13.

Example 59 includes the subject matter of any one of Examples 33-58, and optionally, wherein the apparatus is configured to cause the STA to determine that the per AID TID info field is to include the feedback subfield instead of a BA bitmap subfield based on the determination that the Ack type subfield is set to 0 and the TID subfield is set to 13.

Example 60 includes the subject matter of any one of Examples 33-59, and optionally, wherein the STA comprises a non Access Point (non-AP) STA.

Example 61 includes the subject matter of any one of Examples 33-59, and optionally, wherein the STA comprises an Access Point (AP) STA.

Example 62 includes the subject matter of any one of Examples 33-61, and optionally, wherein the STA comprises an Ultra High Reliability (UHR) STA.

Example 63 includes the subject matter of any one of Examples 33-62, and optionally, comprising a radio to receive the multi-STA BA frame.

Example 64 includes the subject matter of Example 63, and optionally, comprising one or more antennas connected to the radio, and another processor to execute instructions of an operating system.

Example 65 includes a wireless communication device comprising the apparatus of any of Examples 1-64.

Example 66 includes a mobile device comprising the apparatus of any of Examples 1-64.

Example 67 includes an apparatus comprising means for executing any of the described operations of any of Examples 1-64.

Example 68 includes a product comprising one or more tangible computer-readable non-transitory storage media comprising instructions operable to, when executed by at least one processor, enable the at least one processor to cause a wireless communication device to perform any of the described operations of any of Examples 1-64.

Example 69 includes an apparatus comprising: a memory interface; and processing circuitry configured to: perform any of the described operations of any of Examples 1-64.

Example 70 includes a method comprising any of the described operations of any of Examples 1-64.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
a processor configured to cause a wireless communication station (STA) to:
set an acknowledge (Ack) type subfield in a per Association Identifier (AID) Traffic Identifier (TID) Information (info) field to 0 and a TID subfield in the per AID TID info field to 13 to indicate that the per AID TID info field is to include feedback information;
set the feedback information in a feedback subfield in the per AID TID info field; and
transmit a multi-STA Block Ack (BA) frame comprising the per AID TID info field; and
a memory to store information processed by the processor.

2. The apparatus of claim 1 configured to cause the STA to set a BA starting sequence control subfield in the per AID TID info field to indicate a length of the feedback subfield.

3. The apparatus of claim 2 configured to cause the STA to set the BA starting sequence control subfield in the per AID TID info field to indicate a selected length from a plurality of predefined lengths, the selected length based on the length of the feedback subfield.

4. The apparatus of claim 2 configured to cause the STA to set a fragment number subfield in the BA starting sequence control subfield to indicate the length of the feedback subfield.

5. The apparatus of claim 1 configured to cause the STA to set an AID subfield in the per AID TID info field to a predefined AID value to indicate that the feedback information is intended for all receiving STAs.

6. The apparatus of claim 5, wherein the predefined AID value is 2008.

7. The apparatus of claim 5 configured to cause the STA to broadcast the multi-STA BA frame.

8. The apparatus of claim 1 configured to cause the STA to set an AID subfield in the per AID TID info field to an AID of an intended receiver STA for the feedback information.

9. The apparatus of claim 8 configured to cause the STA to transmit the multi-STA BA frame as a unicast frame addressed to the intended receiver STA.

10. The apparatus of claim 1 configured to cause the STA to set the feedback information comprising unavailability information.

11. The apparatus of claim 1 configured to cause the STA to set the feedback subfield comprising an unavailability target start time subfield, and an unavailability duration subfield.

12. The apparatus of claim 1 configured to cause the STA to set the feedback information comprising coexistence information.

13. The apparatus of claim 1 configured to cause the STA to set the feedback information comprising link adaptation information.

14. The apparatus of claim 1 configured to cause the STA to set the feedback information comprising an indication of a receive status due to interference.

15. The apparatus of claim 1 configured to cause the STA to set the feedback information comprising parameter negotiation information.

16. The apparatus of claim 1 configured to cause the STA to set a feedback type subfield in the feedback subfield to indicate a type of the feedback information.

17. The apparatus of claim 1 comprising a radio to transmit the multi-STA BA frame.

18. The apparatus of claim 17 comprising one or more antennas connected to the radio, and another processor to execute instructions of an operating system.

19. A product comprising one or more tangible computer-readable non-transitory storage media comprising instructions operable to, when executed by at least one processor, enable the at least one processor to cause a wireless communication station (STA) to:
set an acknowledge (Ack) type subfield in a per Association Identifier (AID) Traffic Identifier (TID) Information (info) field to 0 and a TID subfield in the per AID TID info field to 13 to indicate that the per AID TID info field is to include feedback information;
set the feedback information in a feedback subfield in the per AID TID info field; and
transmit a multi-STA Block Ack (BA) frame comprising the per AID TID info field.

20. The product of claim 19, wherein the instructions, when executed, cause the STA to set an AID subfield in the per AID TID info field to a predefined AID value to indicate that the feedback information is intended for all receiving STAs.
